(19) United States
(12) Patent Application Publication
(10) Pub. No.: US 2006/0033297 A1
(43) Pub. Date: Feb. 16, 2006

(54) Collapsible walker for injured person

(76) Inventor: Michael L. Miller, Boca Raton, FL (US)

Correspondence Address: MARVIN N. GORDON, 277 WEST END AVE., NEW YORK, NY, 10023, US

(21) Appl. No.: 10/916,288

(22) Filed: Aug. 12, 2004

(51) Int. Cl. B62M 1/00

(52) U.S. Cl. 280/87.021

(57) ABSTRACT

A mobile vehicle for use by a person having one disabled leg includes a transverse member mounted for pivotable movement with respect to the vehicle's front wheel to allow the vehicle to be folded into a more compact configuration when it is not in use. The vehicle also includes a leg rest whose vertical position can be adjusted.

### BACKGROUND OF THE INVENTION

1. Field of the Invention

The present invention relates generally to self-propelled support vehicles, and more particularly to a wheeled, collapsible vehicle for use by an individual having one leg that is injured or otherwise disabled and incapable of use in walking.

2. Description of the Prior Art

As the population ages, there has been an increased use of walkers or other types of mobile support vehicles to assist disabled persons to move about. One type of support vehicle that has been developed is one for use, often as an alternative to the use of crutches, wheel chairs or conventional walkers, by an individual who has one leg or ankle that is injured, disabled, unable to bear weight, or otherwise non-ambulatory, and another leg that is capable of relatively normal use. In these vehicles, or carts as they are sometimes called, the user rests his or her disabled leg on a rest or support and uses the other, ambulatory leg for propulsion. The prior support vehicles of this type each, however, has a major drawback or disadvantage that heretofore has limited their use by individuals who would otherwise greatly benefit from their use.

For example, U.S. Pat. No. 5,800,317 discloses a non-foldable, four-wheel vehicle, which cannot be steered and is therefore awkward and cumbersome to use in anything but straight-line movement. U.S. Pat. No, 5,839,749 discloses a three-wheel cart. Two of the wheels are in the front of the cart whereas the third, steerable wheel is in the rear of the cart. Steering of the cart is achieved by the manipulation of two handles that exert torque on the front two wheels, which, in turn, causes the rear wheel to swing either to the left or to the right, thereby to accomplish the desired change in direction. The cart disclosed in this patent is assembled for use for by a person with either an injured left leg or an injured right leg, which limits its use by several injured people in a group, such as residents of an assisted living facility or nursing facility where the non-ambulatory leg of the various group members in need of such an aid to mobility is the right leg for some and the left leg for others. The vehicle disclosed in this patent is also not foldable.

U.S. Pat. No. 6,634,660 discloses a four-wheeled vehicle that, although stable, is steered by the exertion of torque to the front wheels through handle bars, which cause caster-type front wheels to turn. Turning of the vehicle is accomplished by allowing the front wheels to swivel and turn separately. The vehicle disclosed in this patent is thus cumbersome in use and awkward to steer. It is also relatively large and not foldable.

There thus remains a need for a lightweight, foldable mobile cart or vehicle for use by individuals with one non-ambulatory or disabled leg, such as individuals who have suffered an injury to their lower leg, foot or ankle, and who thus who cannot place weight on the injured leg, that is stable, light in weight, foldable, portable, compact and easy to steer both forward and in reverse, and which may be used irrespective of which of the user's legs is non-ambulatory.

### SUMMARY OF THE INVENTION

The mobile support vehicle of the present invention includes a pair of rear wheels and a pivotable and thus steerable front wheel. A transverse column extends between the front and rear wheels and a steering column including handle bars is coupled at its lower end to the front wheel. A leg support is mounted centrally to the transverse column and is adjustable in height as well to allow its comfortable use by more than one person irrespective of which of the user's legs is non-ambulatory. The vertical position of the handle bar may also be adjusted to best conform to the height of the user. The transverse column can be pivoted relative to the front wheel when the vehicle is not in use to fold the vehicle into a more compact configuration for easier handling, transporting to a new location and storage. The vehicle can be steered by operation of the handle bar in both the forward and reverse directions. Also included is a hand brake located on the handle bar, which allows the vehicle to be secured in one location for as long as desired.

To the accomplishment of the above and such further objects as may hereinafter appear, the present invention relates to a mobile support vehicle substantially as defined in the appended claims as considered in conjunction with the following detailed description of a preferred embodiment thereof along with the accompanying drawings in which:

### BRIEF DESCRIPTION OF THE DRAWINGS

FIG. 1 is an elevation of a mobile support vehicle in accordance with an embodiment of the invention;

FIG. 2 is a cross-section taken along the lines 2-2 of FIG. 1;

FIG. 3 is a cross-section taken along the lines 3-3 of FIG. 1;

FIG. 4 is a cross-section taken across lines 4-4 of FIG. 2;

FIG. 5 is a cross-section viewed along the lines 5-5 in FIG. 2;

FIG. 6 is a cross-section viewed along the lines 6-6 in FIG. 1;

FIG. 7 is a cross-section taken along the lines 7-7 of FIG. 1; and

FIG. 8 is an elevation of the vehicle of the invention in its folded, more compact configuration.

### DETAILED DESCRIPTION OF THE PREFERRED EMBODIMENT

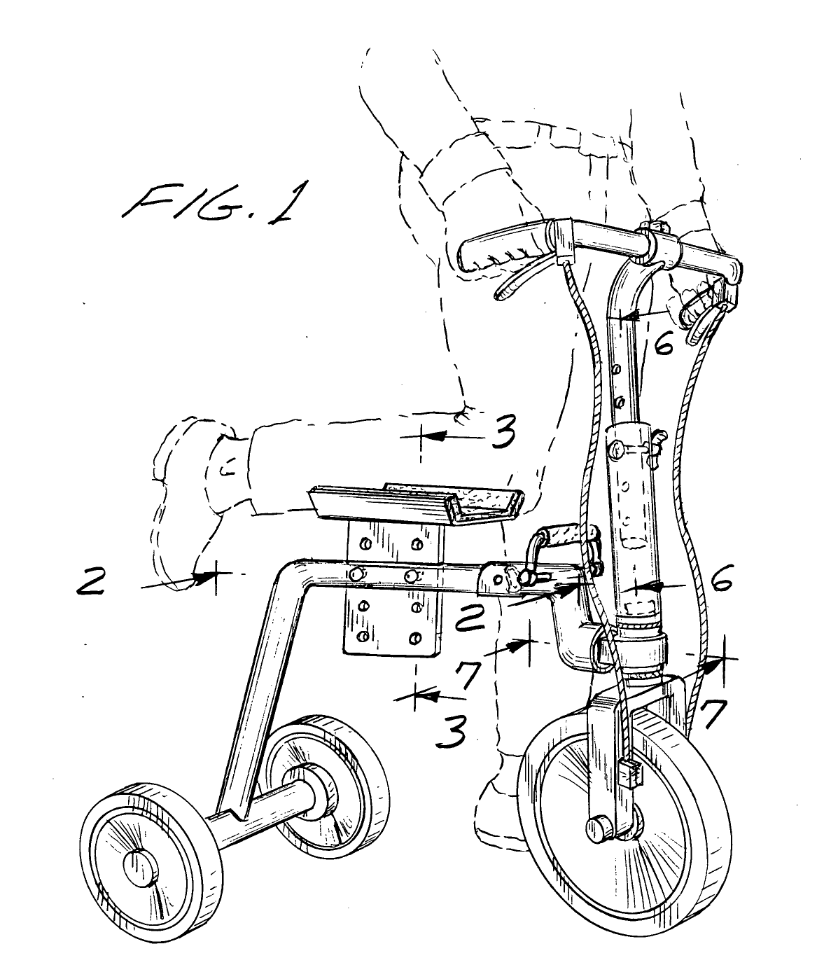

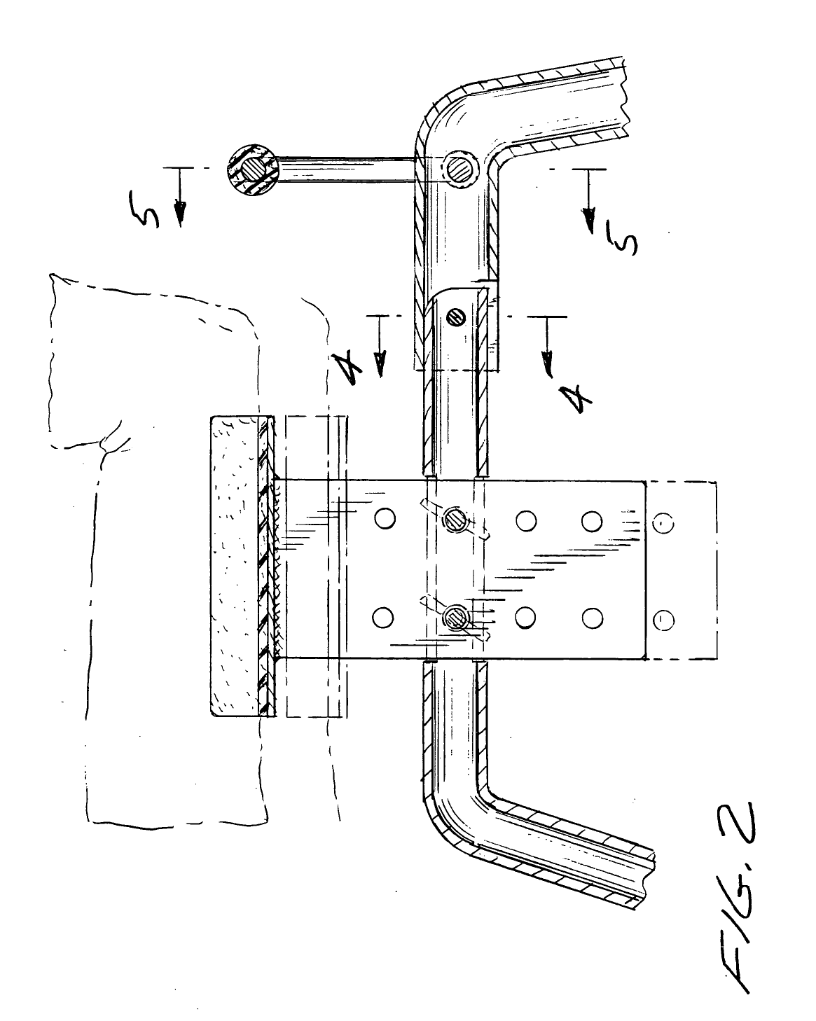

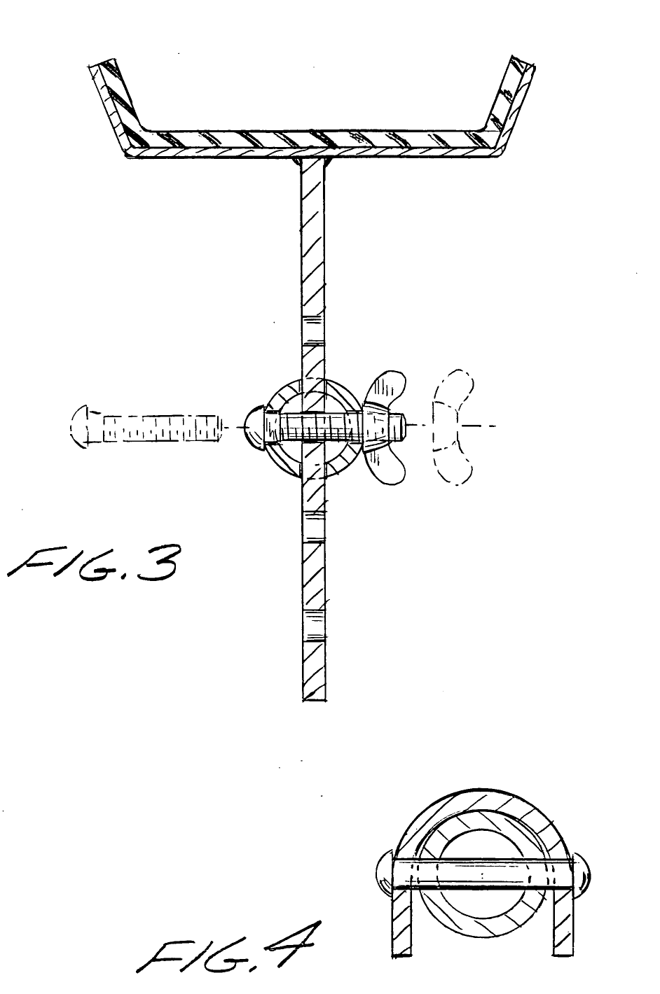

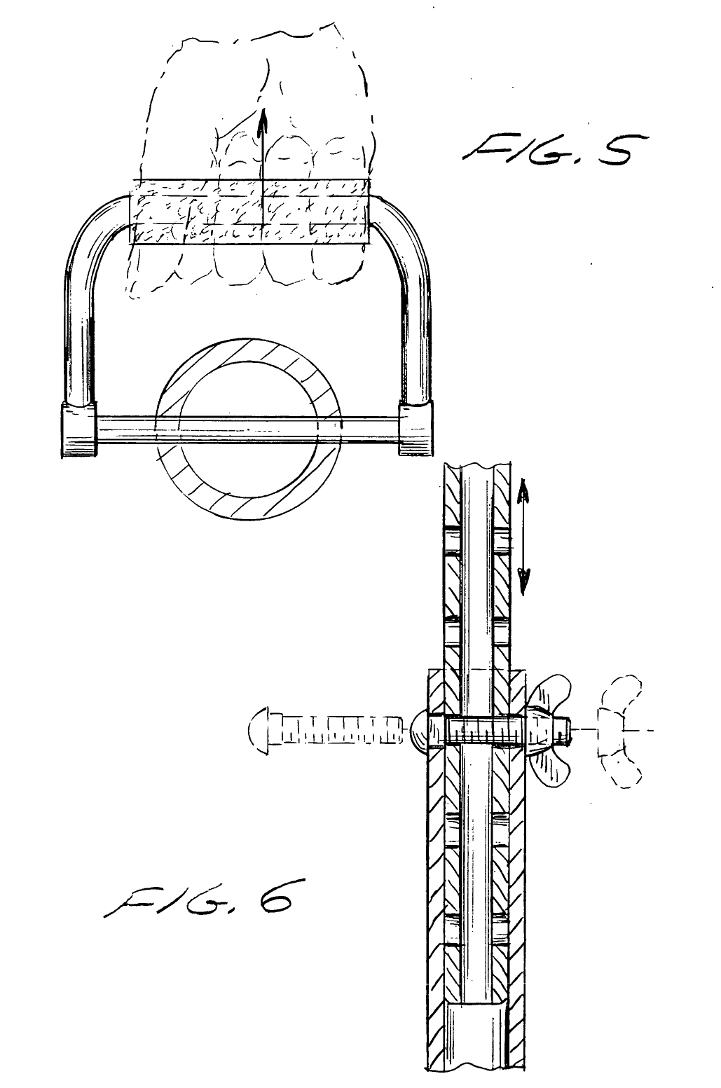

Referring to the drawings, FIG. 1 illustrates a mobile support vehicle, generally designated 10, in accordance with an embodiment of the present invention, as used by a person 12 depicted in broken lines. As therein shown, vehicle 10 is generally in the form of a tricycle having a frame 14, a front wheel 16 and a pair of rear wheels 18 and 20 rotatably mounted to the ends of a rear axle 22. Axle 22 is secured to the lower end of a tube 24, which is bent at 26 and then extends to define a transverse tubular member 28. The free end of transverse member 28 is received within one end 30 of an L-shaped tubular member 32. As seen most clearly in FIGS. 2 and 4, transverse member 28 is pivotably secured at its foreward end to member 32 by means of a pin 34, which, as seen in FIG. 5, passes through both transverse member 28 and L-shaped tubular member 32.

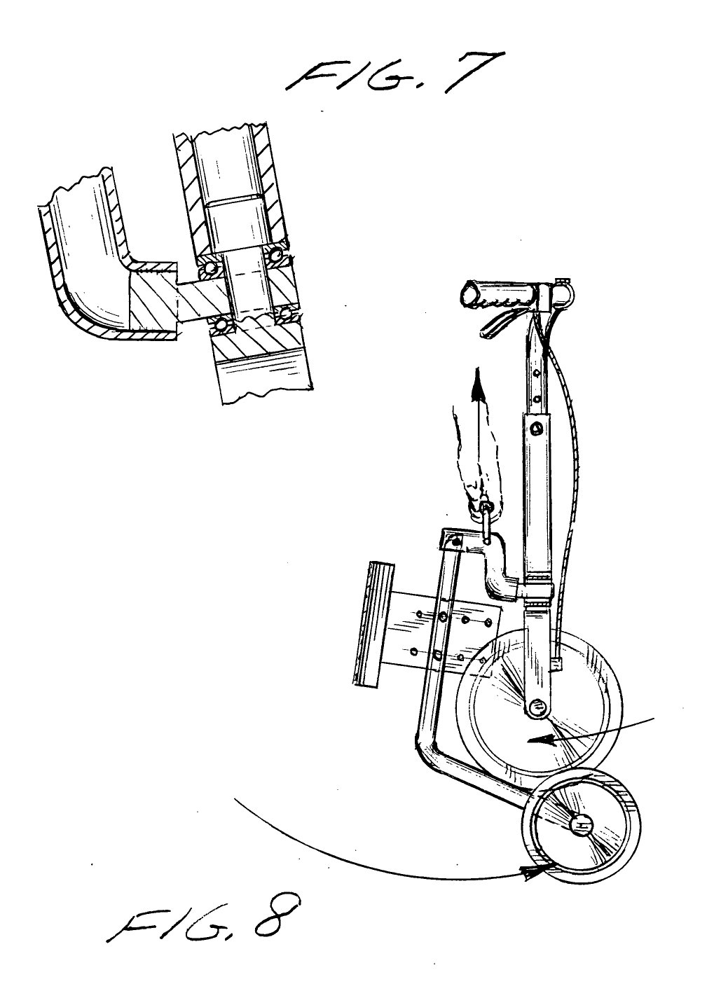

As can be seen in FIG. 7, the lower, opposite open end 40 of tubular member 32 securely receives one end 42 of a bearing sleeve 44, which, in turn, encircles a narrow section 46 of a steering column 48. Steering column 48 receives at its lower end the mounting section 50 of a wheel bracket 52 to which front wheel 16 is rotatably mounted. Bearings 54 (FIG. 7) facilitate the rotation of bracket 52 with respect to the steering column.

The upper end of steering column 48 telescopically receives the lower end of a steering tube 56, which includes a series of axially spaced openings 58. A wing nut 60 is passed through one of openings 58 and through an aligned opening 62 in column 48. A handle bar 64 is secured to the upper end of tube 56, and conventional bicycle hand brakes 66 mounted to the handle bar include cables 68 that extend to the rim of the front wheel 16.

A padded trough-shaped leg support or rest 70 is secured to the upper end of a mounting bracket 72, which includes two rows of horizontally aligned openings 74. As seen best in FIGS. 2 and 3, bracket 72 passes through a centrally disposed rectangular opening 76 in transverse member 28, and is secured thereto by means of a pair of wing nuts 78 that extends through transverse member 28 and through a selected pair of aligned openings 74 in the bracket 72.

The relative vertical position of both leg support 70 and handle bar 64 can be adjusted, the former by releasing wing nuts 78 and then inserting and tightening it through a selected different pair of openings 74 (FIG. 3) so that the leg rest 70 is thereby positioned at the desired optimal height for the user. Similarly, the relative height of handle bar 64 can be adjusted to the desired height by releasing the wing nut 60 and then inserting it through a different one of the openings 62.

As seen best in FIG. 8, the vehicle 10 of the present invention may be collapsed or folded when not in use to make it more compact and thus easier to store and carry from place to place. As therein shown, in order to fold the vehicle, the user exerts an upward force on handle 36 to cause transverse member 28 to rise and to pass through a lower cutout 80 (FIG. 4) formed along the lower edge of tubular member 32 and thereby pivot about pin 34 in a downward, counterclockwise direction (as viewed in FIG. 1) until it reaches the final, collapsed position shown in FIG. 8. The handle 36 can then be grasped to carry and transport the collapsed vehicle to the next desired location.

In use, as shown in FIG. 1, the user 12 places the knee and part of the lower portion of the disabled leg on leg support 70 and rests the other, healthy leg on the ground. The user holds on to the handle bar and propels the vehicle by pushing off with the healthy leg as in the operation of a scooter. Steering and braking of the moving vehicle are respectively controlled by the operation of the handle bar and hand brakes as in the operation of a bicycle.

It will be appreciated from the foregoing description of a presently preferred embodiment that the vehicle of the invention offers numerous advantages in terms of convenience of use, ease of storage and transport in the collapsed state. It will also be appreciated by those of ordinary skill in the art that modifications may be made to the embodiment specifically described above without necessarily departing from the spirit and scope of the invention.

What is claimed is:

1. A mobile vehicle for use by a person having one disabled leg comprising: a pair of rear wheels, a single front wheel, a steering column coupled at its lower end to said front wheel for imparting steering control to said front wheel, a transverse column secured at one of its ends to said steering column and at its other end to said pair of rear wheels, a support for the user's disabled leg, bracket means coupled to said transverse bar intermediate said front and rear wheels and also coupled to said leg support, and securing means engaging said transverse column and allowing said transverse column to be pivoted relative to said front wheel, thereby to permit the user to fold the vehicle.

2. The vehicle of claim 1, in which said bracket means includes means for selectively adjusting the relative vertical position of said leg support with respect to said transverse column.

3. The vehicle of claim 2, further comprising means for adjusting the relative vertical position of said steering column with respect to said transverse column

4. The vehicle of claim 1, further comprising a handle bar secured to the upper end of said steering column, brake means carried by said handle bar for supplying braking action to said front wheel, and means associated with said handle bar for adjusting the relative vertical position of said handle bar.

5. The vehicle of claim 1, further comprising a tubular member receiving one end of said transverse member at one of its ends, said securing means including a pin passing through said transverse member and said tubular member for allowing relative pivoting motion between said transverse member and said tubular member along an axis adjacent said one end of said transverse member.

6. The vehicle of claim 5, in which a cutout is provided at said one end of said tubular member adjacent said pin to allow said one end of said transverse member to pass therethrough when it is pivoted relative to said tubular member.

7. The vehicle of claim 6, further comprising a handle secured to said tubular member and effective when a vertical force is imparted thereto to cause relative pivotable movement of said transverse member, causing the vehicle to fold to a more contact configuration, said handle thereafter serving as a means to grasp and carry the thus folded vehicle.
